(19) United States
(12) Patent Application Publication
(10) Pub. No.: US 2015/0220371 A1
(43) Pub. Date: Aug. 6, 2015

(54) ENERGY AWARE INFORMATION PROCESSING FRAMEWORK FOR COMPUTATION AND COMMUNICATION DEVICES COUPLED TO A CLOUD

(71) Applicants: Rongzhen YANG, (US); Hujun YIN, Saratoga, CA (US); Feng CHEN, Shanghai (CN); Johnson Z. WU, Shanghai (CN); Yan Mars HAO, Shanghai (CN); Yi YANG, Shanghai (CN); INTEL CORPORATION, SANTA CLARA, CA (US)

(72) Inventors: Rongzhen Yang, Shanghai (CN); Hujun Yin, Saratoga, CA (US); Feng Chen, Shanghai (CN); Johnson Z. Wu, Shanghai (CN); Yan Hao, Shanghai (CN); Yi Yang, Shanghai (CN)

(21) Appl. No.: 14/128,563

(22) PCT Filed: Mar. 4, 2013
(86) PCT No.: PCT/CN13/72125

§ 371 Date: Dec. 20, 2013

(51) Int. Cl. G06F 9/50; G06F 9/48

(52) U.S. Cl. CPC G06F 9/5094; G06F 9/4893

(57) ABSTRACT

An energy aware framework for computation and communication devices (CCDs) is disclosed. CCDs may support applications, which may participate in energy aware optimization. Such applications may be designed to support execution modes, which may be associated with different computation and communication demands or requirements. An optimization block may collect computation requirement values (CRV_{M}), communication demand values (CDV_{M}), and such other values of each execution mode to perform a specific task(s). The optimization block may collect computation energy cost information (CECI_{M}) and multi-radio communication energy cost information (MCECI_{M}) for each execution mode. Also, the optimization block may collect the workload values of a cloud-side processing device. The optimization block may determine power estimation values (PEV), based on the energy cost values (CECI_{M}), (MCECI_{M}), CRV_{M}, and CDV_{M}. The optimization block may then determine the execution mode or the apparatus best suited to perform the tasks.

### FIELD OF THE INVENTION

This disclosure pertains to energy conservation in computation and communication platforms, as well as code to execute thereon, and in particular but not exclusively, to energy aware information processing framework for computation and communication devices (CCDs) coupled to a cloud.

### BACKGROUND

The present and future generation of computation and communication devices (CCDs) are, increasingly, becoming capable of information collection, processing and communicating to other electronic devices. Such CCDs have the ability to support multiple sensors to collect several types of information and are capable of supporting enhanced speed and broadband connectivity as well. For example, the CCDs may be designed to support multiple sensors such as microphone, video camera to collect information. Also, such CCDs may support communication technologies and standards such as Wi-Fi, 3G, and Long term evolution (LTE) to enable the CCDs to transfer the information to cloud based devices to support applications such as augmented reality.

However, the efficiency and user experience with which such applications may be supported may be based on various factors such as processing capability of the processors, speed of communication supported by various radio (or communication) technologies, conditions of the channel over which the bits are transmitted. Another, major factor that affects the overall power consumption of the CCDs is the power consumed by each of these various factors. The present CCDs may not be equipped with one or more techniques to provide a holistic approach to load balancing to achieve optimum power and performance efficiencies. The present techniques may be equipped, for example, the power consumption of one or few components within the CCDs without considering the impact of such techniques on other portions of the CCDs thus providing not so optimal power and performance efficiencies.

### BRIEF DESCRIPTION OF THE DRAWINGS

The embodiments of the invention described herein are illustrated by way of examples and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates a computing environment 100, which may support energy aware information processing framework for computation and communication devices (CCDs) coupled to a cloud in accordance with one embodiment.

FIG. 2 illustrates a computing platform, which may be used in a CCD to support energy aware information processing framework for computation and communication devices (CCDs) in accordance with one embodiment.

FIG. 3 illustrates a computing platform, which may be used in a cloud processing device to support energy aware information processing framework for computation and communication devices (CCDs) in accordance with one embodiment.

FIG. 4 is a flow-chart, which illustrates an operation of the CCD to support energy aware information processing framework for computation and communication devices (CCDs) in accordance with one embodiment.

FIG. 5 is a flow-chart, which illustrates an operation of the cloud processing device to support energy aware information processing framework for computation and communication devices (CCDs) in accordance with one embodiment.

FIG. 6 is a computer system, which may support energy aware information processing framework for computation and communication devices (CCDs) in accordance with one embodiment.

### DETAILED DESCRIPTION

The following description describes embodiments of one or more techniques to support energy aware information processing framework for computation and communication devices (CCDs). In the following description, numerous specific details such as logic implementations, resource partitioning, or sharing, or duplication implementations, types and interrelationships of system components, and logic partitioning or integration choices are set forth in order to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device).

For example, a machine-readable medium may include read only memory (ROM); random access memory (RAM); magnetic disk storage media; optical storage media; flash memory devices; electrical, optical, acoustical or other similar signals. Further, firmware, software, routines, and instructions may be described herein as performing certain actions. However, it should be appreciated that such descriptions are merely for convenience and that such actions in fact result from computing devices, processors, controllers, and other devices executing the firmware, software, routines, and instructions.

In one embodiment, a novel architecture in which power consumption may be optimized in CCDs and the cloud processing devices coupled with the CCDs is disclosed. In one embodiment, the client side CCDs may support one or more applications, which may participate in energy aware optimization. In one embodiment, such applications may be designed to support one or more execution modes. In one embodiment, the one or more execution modes may be associated with different computation and communication demands or requirements. In one embodiment, the one or more execution modes may provide different or nearly the same user experience. In one embodiment, a client-side CCDs (or a platform provided in the client-side CCD) may include one or more optimization blocks. In one embodiment, an optimization block may collect one or more computation requirement values (CRV_{M}), communication demand values (CDV_{M}), and latency requirement information (LRI_{M}) associated with the one or more execution modes of the applications. In one embodiment, ‘M’ represents an identifier of the execution mode of an application. In one embodiment, the one or more computation values and communication values of the one or more execution modes may represent a demand or a requirement of that execution mode to perform a specific task(s). Further, the optimization block may collect computation capability values (CCV1) (such as instructions performed in a unit time e.g., MIPS) of the processor components to perform the tasks, of the application, in the one or more execution modes. Also, the optimization block may collect the communication capability value (CCV2) such as total communication bits or bandwidth (bits/second) required by each of the one or more execution modes to transfer the communication bits to a cloud processing device, for example. In one embodiment, the optimization block may determine computation energy cost information values and communication energy cost information values based on the CCV1 and CCV2. In other embodiments, the optimization block may receive the computation and communication energy cost information values from the operating system and in such a circumstance the operating system may collect the CCV1 and CCV2 directly from the hardware platform 201. In other embodiment, the optimization block may collect scheduled workloads of the one or more processor components provided in the hardware platform. In one embodiment, the workload schedule of the one or more processing cores or processor components may represent the ability of the one or more processing cores to perform additional work along with an already scheduled work.

Also, the optimization block may collect one or more energy cost values such as a computation energy cost information (CECI_{M}) (e.g., joule/MIPS) and multi-radio communication energy cost information (MCECI_{M}) (e.g., joule/bit) for each execution mode. In one embodiment, the operating system may collect the CCV1 and CCV2 and then, respectively, determine the CECI_{M} and MCECI_{M} based on the CCV1 and CCV2 values. Further, the optimization block may collect the workload values of a cloud-side processing device such as a cloud server or such other cloud based devices. In one embodiment, the optimization block may determine, based on the values collected (e.g., CRV_{M}, CDV_{M}, CCV1, CCV2, CECI_{M}, MCECI_{M}), the apparatus (client-side device or cloud-side processing device) best suited to perform the tasks to enhance the performance, user experience, and reduce power consumption. In one embodiment, the optimization block may identify the execution mode in which the task(s) may be performed in the client-side device if the optimization block determines that the client-side device may be best suited to perform the tasks. In one embodiment, the optimization block may cause the tasks to be offloaded to the cloud-side processing device if the optimization block determines that the cloud-side device may be best suited to perform the tasks.

In one embodiment, the cloud-side processing device may include an energy aware load balancing block, which may assess the workload on the cloud-side processing device. In one embodiment, the assessment made by the energy aware load balancing block may be provided to the client-side device. In one embodiment, the assessment made by the energy aware load balancing block may be used to determine if the tasks may be offloaded to the cloud-side processing device as described above.

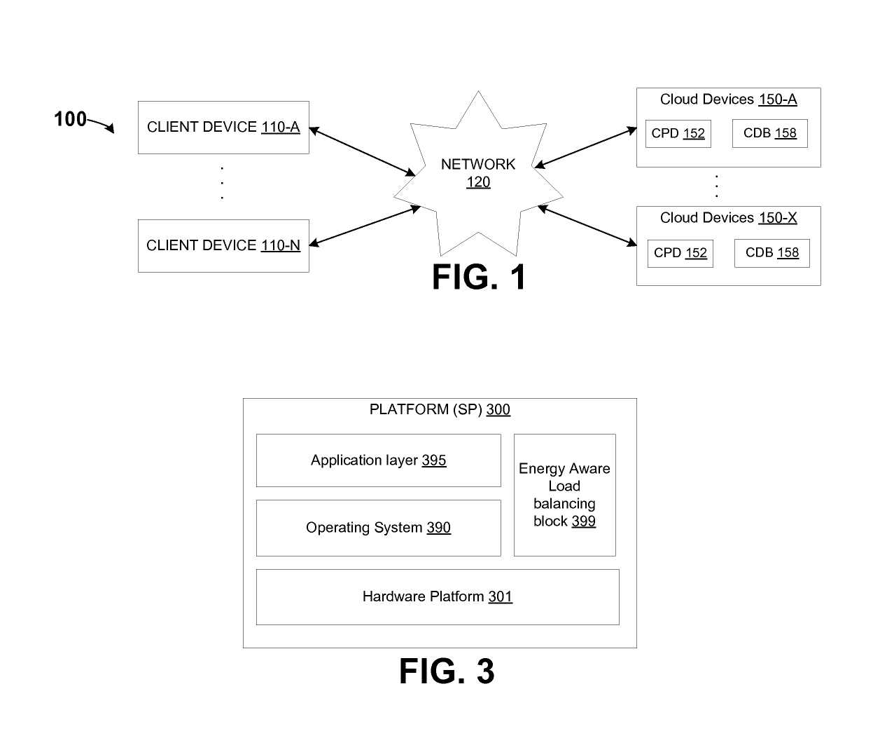

An embodiment of a computing environment 100, which may support energy aware information processing framework for computation and communication devices (CCDs) coupled to a cloud, is illustrated in FIG.1. In one embodiment, the computing environment 100 may include one or more CCDs 110-A to 110-N, a network 120, and one or more cloud devices 150-A to 150-N, which may comprise a cloud processing device (CPD) 152 and a cloud database (CDB) 158. However, the cloud device 150 may comprise many other blocks such as the cloud services block, cloud storage block, cloud servers, and such blocks are not depicted here for brevity.

In one embodiment, the network 120 may comprise one or more network devices such as a switch or a router, which may receive the messages or packets, process the messages, and send the messages to an appropriate network device provisioned in a path to the destination system. The network 120 may enable transfer of messages between one or more of the CCDs 110 and the cloud device 150. The network devices of the network 120 may be configured to support various protocols such as TCP/IP.

In one embodiment, the CCD 110-A may determine the apparatus (client-side device or cloud-side processing device), which may be best suited to perform the tasks (such as speech, voice, image, video, distributed sensor information processing, and augmented reality) to enhance the performance, user experience, and reduce power consumption. In one embodiment, the CCD 110-A may identify the execution mode in which an application is to perform the task(s) in the client-side device if the CCD 110-A determines that the client-side device may be best suited to perform the tasks. In one embodiment, the CCD 110-A may cause the tasks to be offloaded to the cloud-side processing device (e.g., CPD 152 provided in the cloud device 150-A) if the optimization block determines that the cloud-side device may be best suited to perform the tasks.

In one embodiment, the cloud device 150-A may include a cloud processing device (CPD 152), which may assess the workload on the cloud processing device CPD 152. In one embodiment, the assessment made by the cloud processing device CPD 152 may be provided to the CCD 110-A. In one embodiment, the assessment made by the cloud processing device CPD 152 may be used to determine if the tasks may be offloaded to the cloud device 150-A. In one embodiment, the CPD 152 may receive the un-processed data, generate processed data, and send the processed data to the CCD 110-A.

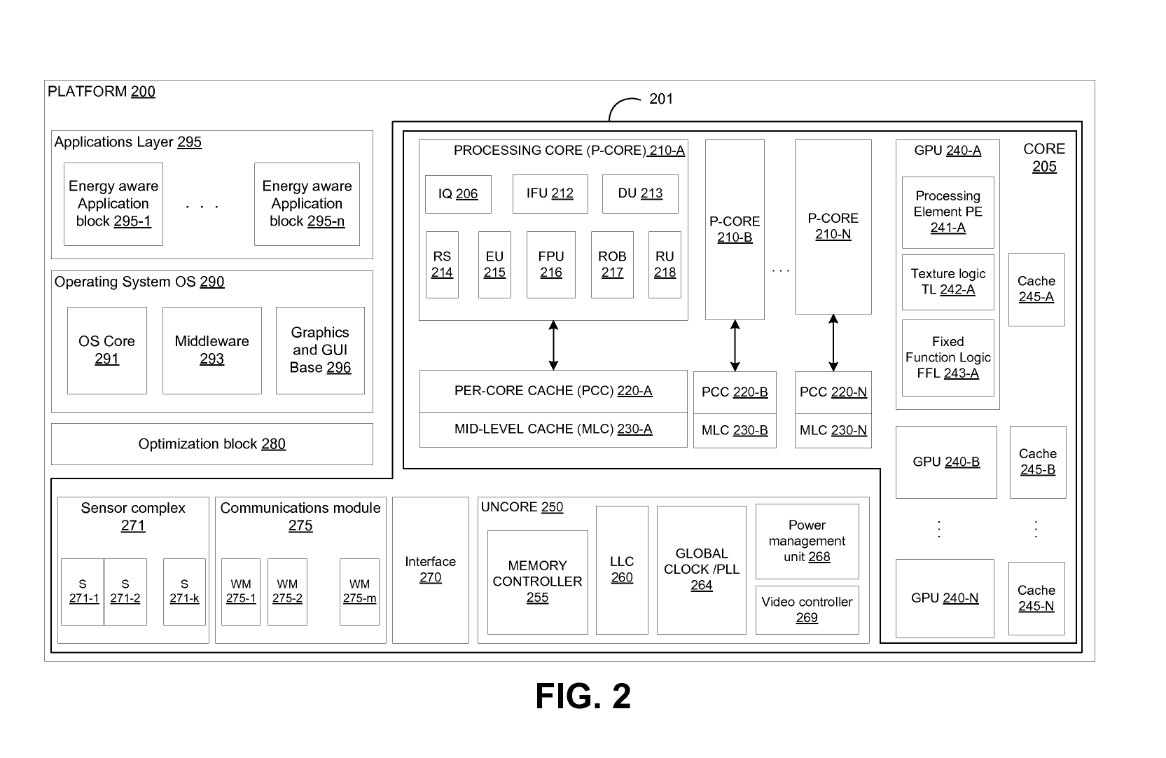

An embodiment of a platform 200, which may be used in the CCD 110-A and the cloud processing device 152 to support energy aware information processing framework for computation and communication devices (CCDs) coupled to a cloud is illustrated in FIG. 2. In one embodiment, the platform 200 may comprise a core area 205, an uncore area 250, I/O interface block 270, a sensor complex 271, a communications module 275, an optimization block 280, an operating system 290, and an applications layer 295. In one embodiment, the core 205 and the uncore 250 may support a point-to-point bi-directional bus to enhance communication between the processing cores (p-cores) 210-A to 210-N, GPUs 240-A and 240-N and between the core area 205 and the uncore area 250.

In one embodiment, the operating system block OS 290 may support one or more operating systems such as Android®, Meego®, iOS®, Windows®, and Windows Phone®. In one embodiment, the OS block OS 290 may support key components such as a kernel, graphic user interface (GUI), drivers, and middleware. In one embodiment, the OS 290 may include OS core 291, which may support the OS kernel, system libraries, device drivers, and such other core OS components. In one embodiment, the middleware 293 may include codes, digital right management (DRM), and such other components, which may provide services to the applications layer 295. In one embodiment, the graphics and GUI base 296 may support user interfaces and advanced graphics features such as 3D rendering. In one embodiment, the OS core 291 may determine one or more energy cost values such as computation energy cost information (CECI_{M}) (e.g., joule/MIPS) and multi-radio communication energy cost information (MCECI_{M}) (e.g., joule/bit) for each execution mode (EM) and provide such values to the optimization block 280. In one embodiment, the CECI_{M} and MCECI_{M} values may represent system features and may be provided by a system designer. In one embodiment, the CECI_{M} may be determined based on the CPU type and the performance curve of the CPU provided by the CPU provider. For example, CECI_{M} values may be based on the CPU execution mode and the current frequency. In one embodiment, the MCECI_{M} values may be provided by the multi-radio component provider. In one embodiment, the CECI_{M} and MCECI_{M} values may be saved as data files and the OS 291 may look-up the data files and choose an appropriate value of CECI and MCECI based on the CPU execution status (i.e., mode and frequency, for example) and the radio type. In other embodiments, the OS core 291 may pre-compute the energy cost values for a number of combinations of CCV1 and CCV2 and store such energy cost values in a look-up table and provide such pre-computed energy cost values to the optimization block.

In one embodiment, the core area 205 may comprise processing cores such as p-cores 210-A to 210-N, per-core caches 220-A to 220-N and mid-level caches 230-A to 230-N associated with the p-cores 210-A to 210-N. In one embodiment, the p-cores 210 may include an instruction queue 206, an instruction fetch unit IFU 212, a decode unit 213, a reservation station RS 214, an execution unit EU 215, a floating point execution unit FPU 216, a re-order buffer ROB 217, and a retirement unit RU 218. In one embodiment, each processor core 210-B to 210-N may each include blocks that are similar to the blocks depicted in the processing core 210-A and the internal details of each of the processing cores 210-B to 210-N is not shown for brevity. In one embodiment, the per-core caches 120 may include memory technologies that may support higher access speeds, which may decrease the latency of instruction and data fetches, for example.

In one embodiment, the computing platform 200 may include one or more graphics processing units (GPUs) 240-A to 240-N and each GPU 240 may include a processing element, a texture logic, and a fixed function logic such as the PE 241-A, TL 242-A, and FFL 243-A, respectively. In one embodiment, the sub-blocks within each of the GPU 240 may be designed to perform video processing tasks, which may include video pre-processing and video post-processing tasks.

In one embodiment, the interface 270 may provide an interface to I/O devices such as the keyboard, mouse, camera, display devices, and such other peripheral devices. In one embodiment, the interface 270 may support, electrical, physical, and protocol interfaces to the peripheral devices. In one embodiment, the interface 270 may provide an interface to the network such as the network 120. In one embodiment, the interface 270 may support, electrical, physical, and protocol interfaces to the network 120. In one embodiment, the interface 270 may couple the computing platform 200 to a display device.

Further, the sensor complex 271 may include one or more sensors S271-1 to S271-n. In one embodiment, the sensors S271-1 to 271-n may include accelerometers (G-Sensor), heat sensors, light sensors, and such other sensors, which may provide a powerful means to collect information. In one embodiment, the communications module 275 may include one or more wireless modems WM 275-1 to 275-m, which may include, for example, long term evolution (LTE) modems, Wi-Fi modems based on IEEE® 802.11a, IEEE® 802.11b, IEEE® 802.11g, IEEE® 802.11n, IEEE® 802.11ac, and such other standards, and 3G (e.g., WCDMA) modems.

In one embodiment, the uncore area 250 may include a memory controller 255, LLC 260, a global clock/PLL 264, a power management unit 268, and a video controller 269. In one embodiment, the memory controller 255 may interface with the memory devices such as the hard disk and solid state drives. In one embodiment, the global clock/PLL 264 may provide clock signals to different portions or blocks of the computing platform 200. In one embodiment, the video controller 269 may control the operations of one or more video processing devices.

In one embodiment, the power management unit 268 may control the clock signal to portions of the platform 200, which may be divided as voltage planes and power planes. In one embodiment, the power management unit 268 may control the different planes based on the workload, activity, temperature, or any other such indicators associated with such planes. In one embodiment, the power management unit 268 may implement power management techniques such as dynamic voltage and frequency scaling, power gating, turbo mode, throttling, clock gating, and such other techniques. In one embodiment, the power management unit 268 may collect the computation capability values (CCV1) from the processing cores (P-core 210-A to 210-N) and GPUs 240-A to 240-N and the uncore area 250 and provide such CCV1 to the optimization block 280. Further, the power management unit 268 may collect communication capability values (CCV2) from the communications module 275 and provide such communication capability values (CCV2) to the optimization block 280. In one embodiment, the power management unit 268 may collect CCV1 at regular intervals of time. In other embodiments, the power management unit 268 may collect CCV1 in response to receiving a request form the optimization block 280.

In one embodiment, the applications layer 295 may include applications, which may call functionalities provided by the modules in the OS 290. In one embodiment, the applications layer 295 may support one or more energy aware applications 295-1 to 295-n and the energy aware applications may support various execution modes. In one embodiment, the energy aware application 295-1 (Siri application, for example) may support, for example, two execution modes (EM1 and EM2) and each of these execution modes may be associated with different computation requirement values (CRV1 for EM1 and CRV2 for EM2) and communication demand values (CDV1 for EM1 and CDV2 for EM2).

As indicated above, the platform 200 may be used in the CCD such as 110-A and the cloud device 150-A. While the platform 200 is used in the CCD 110-A, the optimization block 280 may perform one or more of the operations described below. In one embodiment, the optimization block 280 may collect one or more computation requirement values (CRV) and communication demand values (CDV) associated with the one or more execution modes (EM1 and EM2 of application 1, for example) of the applications. In one embodiment, the optimization block 280 may receive (CRV1 and CDV1) for EM1 and (CRV2 and CDV2) for EM2.

For example, a ‘Siri’ application may be provided in a device (such as a smart phone, tablet, notebook, ultrabook®, laptop or any other such form factor device) may operate in one of the two execution modes viz HiFi voice sampling mode (EM1) and local automatic speech recognition (ASR) (EM2) mode. In one embodiment, while using the HiFi voice sampling mode, the CCD 110-A may send the sampled HiFi voice data bits (unprocessed data) to the cloud device 150-A without pre-processing voice data bits. This may result in a low computation requirement value (CRV1) (of less than 1 MIPS, for example) in the CCD 110-A and a substantially high communication demand value (CDV1) (more than 200 k bits/sec, for example) for sending the voice data bits to the cloud device 150-A. In the local ASR mode, most of the feature extraction (pre-processing) may be performed at the CCD 110-A requiring a substantially higher computation requirement value (CRV2) of 100 MIPS, for example and a lower communication demand value (CDV2) of 130 bits/sec, for example.

Further, the optimization block 280 may collect computation capability values (CCV1) (such as instructions, which may be performed in a unit time e.g., MIPS) of the processor components such as CPUs and GPUs to perform the tasks in the one or more execution modes. In other embodiment, the optimization block 280 may receive workload indication values (WIV) of the one or more processor components provided in the hardware platform 201. Also, the optimization block 280 may receive or retrieve the communication capability value (CCV2) such as total communication bits or bandwidth (bits/second) required by each of the one or more execution modes to transfer the communication bits to a cloud processing device 152. For example, the optimization block 280 may receive, for example, 80 MIPS (=CCV1) and 250 k bits/sec (=CCV2) in response to a request sent by the optimization block 280.

Also, the optimization block 280 may collect energy cost values such as computation energy cost information (CECI_1 and CECI_2) (e.g., joule/MIPS) and multi-radio communication energy cost information (MCECI_1 and MCECI_2) (e.g., joule/bit), respectively, for the execution modes EM1 and EM2. In one embodiment, the optimization block 280 may collect such information from the OS block 290. Further, the optimization block 280 may collect the workload values of a cloud-side processing device such as a cloud server or such other cloud based devices from the cloud device 150-A.

In one embodiment, the optimization block 280 may use the values collected (e.g., CRV1, CRV2, CDV1, CDV2, CCV1, CCV2, CECI_1, CECI_2, MCECI_1 and MCECI_2) to determine whether the CCD 110-A or the cloud device 150-A is best suited to perform the tasks. In one embodiment, the optimization block 280 may determine the power consumption estimation value (PEV) for each mode using the Equation (1) below:

(Power estimation value)_{M}=[(CECI_{M})×(CRV_{M})]+[(MCECI_{M})×(CDV_{M})] Equation (1)

For example, the PEV value for EM1 may be determined by computing the sum of products of [(CECI_1)×(CRV1)] and [(MCECI_1)×(CDV1)] and that of EM2 may be computed as [(CECI_2)×(CRV2)]+[(MCECI_2)×(CDV2)]. In one embodiment, the optimization block 280 may determine the best suited execution mode (EM) based on the PEVs. In one embodiment, the optimization block 280 may select EM1 if the PEV1 of EM1 is less than the PEV2 of the EM2. In one embodiment, the optimization block 280 may select the cloud device 150-A to perform the tasks if the cloud-device 150-A indicates that the cloud processing device 152 is running on low workloads. In one embodiment, the optimization block 280 may determine the PEV for performing the tasks on the cloud device 150-A and the optimization block 280 may select the cloud device 150-A to perform the tasks if the PEV for the cloud device 150-A is less than PEVs for the execution modes (EM) in the CCD 110-A.

In the above example, the optimization block 280 is depicted outside the hardware platform 201; however, the optimization block 280 may be realized using hardware logic, or software logic, or a combination of hardware and software and firmware logic.

An embodiment of a platform 300 used in the cloud device 150 to support energy aware information processing framework for computation and communication devices (CCDs) coupled to a cloud is illustrated in FIG. 3. In one embodiment, the platform 300 may be similar to the platform 200 and only the differences between the platform 200 and 300 are described here for brevity. In one embodiment, the hardware platform 301, operating system 390, applications layer 395 may be substantially similar to the hardware platform 201, operating system 290, and the applications layer 295, respectively.

In one embodiment, the cloud processing device CPD 152 may include an energy aware load balancing block 399, which may assess the workload on the cloud processing device CPD 152. In one embodiment, the assessment made by the energy aware load balancing block 399 may be provided to the CCD 110-A. In one embodiment, the assessment made by the energy aware load balancing block 399 may be used by the CCD 110-A to determine if the tasks may be offloaded to the cloud processing device CPD 152 as described above.

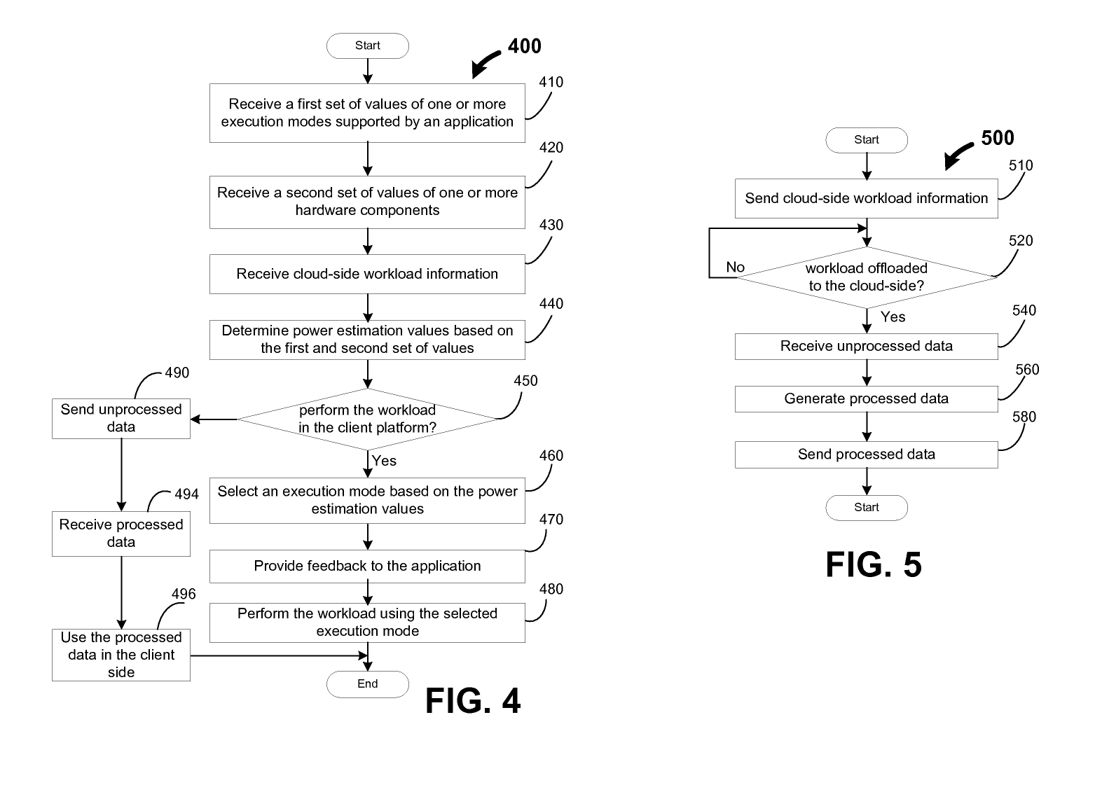

An embodiment of an operation of a CCD (e.g., CCD 110-A), which may support energy aware information processing framework, is illustrated in flow-chart of FIG. 4. In block 410, an optimization block such as the optimization block 280 may receive first set of values of one or more execution modes supported by an application. In one embodiment, the application may be an energy aware application and such an application may support several modes of execution (execution modes). In one embodiment, the optimization block 280 receive first set of values, which may include computation requirement values CRV_{M} and communication demand values CDV_{M} for each execution mode (EM_{M}). For example, the optimization block may receive (CRV_1 and CDV_1) for EM1 and (CRV_2 and CDV_2) for EM2. In one embodiment, the CRV and CDV values may be different for different execution modes. In one embodiment, the CRV may be based on the amount of computation (or processing) performed in that execution mode. In one embodiment, the CDV may be based on the amount of bandwidth (bits/sec) required to communicate with other devices for the associated CRV.

In block 420, the optimization block may receive a second set of values of the one or more hardware components. In one embodiment, the optimization block may collect computation capability values CCV1 and CCV2 and determine the energy cost information values based on the values CCV1 and CCV2. In other embodiments, the optimization block may receive the energy cost values (CECI_1 and CECI_2) (e.g., joule/MIPS) and multi-radio communication energy cost information (MCECI_1 and MCECI_2) (e.g., joule/bit), respectively, for the execution modes EM1 and EM2. In one embodiment, the optimization block may collect such information from an operating system provide in the CCD.

In block 430, the optimization block may receive cloud-side workload information, which may represent the workload schedules of the cloud processing device. In one embodiment, the optimization block may receive cloud-side workload information at regular intervals of times or in response to a request sent from the optimization block.

In block 440, the optimization block or any other block dedicated to determine the power estimation value may determine the power estimation value based on the first and second set of values. In one embodiment, the optimization block may use the values collected [e.g., (CRV1, CDV1, CCV1, CECI_1, and MCECI_1) for EM1] and (CRV2, CDV2, CCV2, CECI_2, and MCECI_2) for EM2] to determine the power estimate values for the execution modes. In one embodiment, the optimization block may determine the power consumption estimation value (PEV) for each mode using the Equation (1) as described above.

In block 450, the optimization block may determine whether a CCD such as a CCD 110-A or the cloud device 150-A is best suited to perform the tasks. Control passes to block 460 if the optimization block determines that CCD 110-A is best suited to perform the tasks and control passes to block 490 if the cloud device 150-A is best suited to perform the tasks.

In block 460, the optimization block may select an execution mode in which the tasks may be performed. In one embodiment, the optimization block may select the execution mode based on the power estimation values. In one embodiment, the optimization block may compare the power estimation values and select an execution mode, which may be associated with a lower power estimation value.

In block 470, the optimization block may provide an indication to the application indicating the execution mode, which is selected to perform the tasks. In block 480, the application in a selected execution mode may perform the workload or the tasks.

In block 490, the optimization block may cause the unprocessed data to be sent to the cloud device. In one embodiment, the unprocessed data may be sent using one of the wireless modems 275-1 to 275-n in the communications block 275. In one embodiment, the optimization block may send an indication to the operating system to have the unprocessed data sent to the cloud device. In other embodiment, the optimization block may directly send an indication to one of the P-cores to have the un-processed data sent to the cloud device.

In block 494, the processed data may be received and the processed data may be used by the application residing in the CCD as depicted in block 496.

An embodiment of an operation of a cloud device, which may support energy aware information processing framework, is illustrated in flow-chart of FIG. 5. In block 510, an energy aware load balancing block such as the block 399 (of FIG. 3) provided in the cloud device may send cloud-side workload information. In one embodiment, the energy aware load balancing block may send such information in response to a request received or such information may be sent at regular intervals. In one embodiment, the energy aware load balancing block may, at regular intervals of time, track the workload information scheduled on the cloud device.

In block 520, the energy aware load balancing block may determine if the workload is offloaded to the cloud device and control passes to block 540 if the workload is offloaded. In block 540, the cloud processing device (such as CPD 152) may receive the unprocessed data and in block 560, the cloud processing device may generate processed data. In block 580, the cloud device may send the processed data.

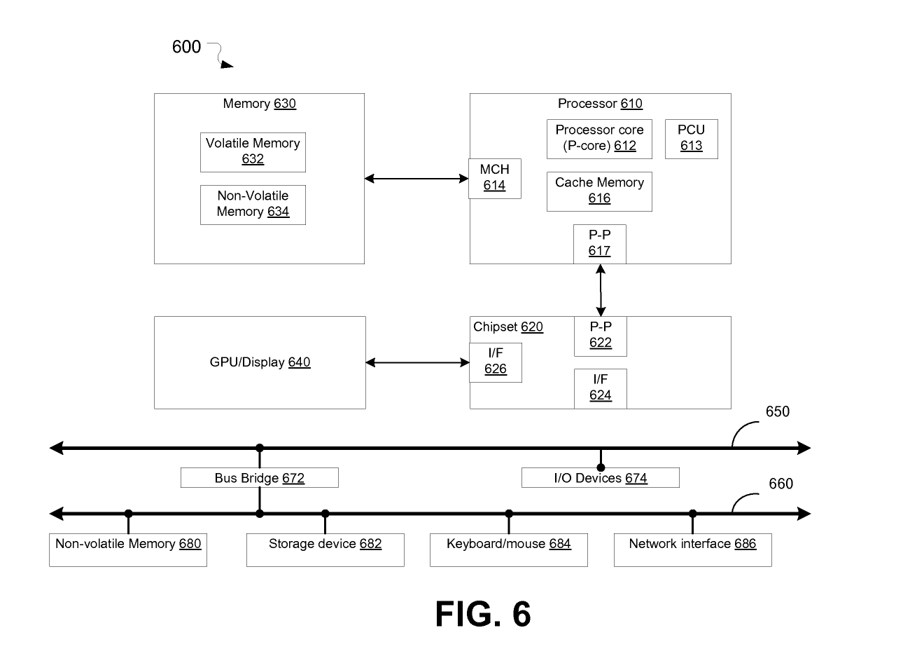

FIG. 6 illustrates a system or platform 600 to implement the methods disclosed herein in accordance with an embodiment of the invention. The system 600 includes, but is not limited to, a desktop computer, a tablet computer, a laptop computer, a netbook, a notebook computer, a personal digital assistant (PDA), a server, a workstation, a cellular telephone, a mobile computing device, a smart phone, an Internet appliance or any other type of computing device. In another embodiment, the system 600 used to implement the methods disclosed herein may be a system on a chip (SOC) system.

The processor 610 has a processing core 512 to execute instructions of the system 600. The processing core 612 includes, but is not limited to, fetch logic to fetch instructions, decode logic to decode the instructions, execution logic to execute instructions and the like. The processor 610 has a cache memory 516 to cache instructions and/or data of the system 600. In another embodiment of the invention, the cache memory 616 includes, but is not limited to, level one, level two and level three, cache memory or any other configuration of the cache memory within the processor 610. In one embodiment of the invention, the processor 610 has a central power control unit PCU 613.

The memory control hub (MCH) 614 performs functions that enable the processor 610 to access and communicate with a memory 630 that includes a volatile memory 632 and/or a non-volatile memory 634. The volatile memory 632 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 634 includes, but is not limited to, NAND flash memory, phase change memory (PCM), read only memory (ROM), electrically erasable programmable read only memory (EEPROM), or any other type of non-volatile memory device.

The memory 630 stores information and instructions to be executed by the processor 610. The memory 630 may also store temporary variables or other intermediate information while the processor 610 is executing instructions. The chipset 620 connects with the processor 510 via Point-to-Point (PtP) interfaces 617 and 622. The chipset 620 enables the processor 610 to connect to other modules in the system 600. In another embodiment of the invention, the chipset 620 is a platform controller hub (PCH). In one embodiment of the invention, the interfaces 617 and 622 operate in accordance with a PtP communication protocol such as the Intel® QuickPath Interconnect (QPI) or the like. The chipset 620 connects to a GPU or a display device 640 that includes, but is not limited to, liquid crystal display (LCD), cathode ray tube (CRT) display, or any other form of visual display device. In another embodiment of the invention, the GPU 640 is not connected to the chipset 620 and is part of the processor 610 (not shown).

In addition, the chipset 620 connects to one or more buses 650 and 660 that interconnect the various modules 674, 680, 682, 684, and 686. Buses 650 and 660 may be interconnected together via a bus bridge 672 if there is a mismatch in bus speed or communication protocol. The chipset 620 couples with, but is not limited to, a non-volatile memory 680, a mass storage device(s) 682, a keyboard/mouse 684 and a network interface 686. The mass storage device 682 includes, but is not limited to, a solid state drive, a hard disk drive, an universal serial bus flash memory drive, or any other form of computer data storage medium. The network interface 686 is implemented using any type of well known network interface standard including, but not limited to, an Ethernet interface, a universal serial bus (USB) interface, a Peripheral Component Interconnect (PCI) Express interface, a wireless interface and/or any other suitable type of interface. The wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 6 are depicted as separate blocks within the system 600, the functions performed by some of these blocks may be integrated within a single semiconductor circuit or may be implemented using two or more separate integrated circuits. The system 600 may include more than one processor/processing core in another embodiment of the invention.

The methods disclosed herein can be implemented in hardware, software, firmware, or any other combination thereof. Although examples of the embodiments of the disclosed subject matter are described, one of ordinary skill in the relevant art will readily appreciate that many other methods of implementing the disclosed subject matter may alternatively be used. In the preceding description, various aspects of the disclosed subject matter have been described. For purposes of explanation, specific numbers, systems and configurations were set forth in order to provide a thorough understanding of the subject matter. However, it is apparent to one skilled in the relevant art having the benefit of this disclosure that the subject matter may be practiced without the specific details. In other instances, well-known features, components, or modules were omitted, simplified, combined, or split in order not to obscure the disclosed subject matter.

The term “is operable” used herein means that the device, system, protocol etc., is able to operate or is adapted to operate for its desired functionality when the device or system is in off-powered state. Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

The techniques shown in the figures can be implemented using code and data stored and executed on one or more computing devices such as general purpose computers or computing devices. Such computing devices store and communicate (internally and with other computing devices over a network) code and data using machine-readable media, such as machine readable storage media (e.g., magnetic disks; optical disks; random access memory; read only memory; flash memory devices; phase-change memory) and machine readable communication media (e.g., electrical, optical, acoustical or other form of propagated signals—such as carrier waves, infrared signals, digital signals, etc.).

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A computation and communication device, comprising:
an application layer, wherein the applications layer to include at least one energy aware application block, wherein the at least one energy aware application block to support a plurality of execution modes,
a hardware platform, wherein the hardware platform to include one or more processing cores, graphics processing units, and a communications block,
an optimization block, wherein the optimization block to determine one of the plurality of execution modes best suited to perform the task based on one or more computation and communication energy cost information values associated with each of the plurality of execution modes.

2. The computation and communication device of claim 1, wherein each of the plurality of execution modes is associated with a computation and communication requirement.

3. The computation and communication device of claim 2, wherein the computation and communication demand values associated with each of the plurality of execution modes is different.

4. The computation and communication device of claim 1, wherein the optimization block to determine the computation and communication energy cost information values based on computation capability values and communication capability values of the hardware platform.

5. The computation and communication device of claim 4, wherein the optimization block to collect the computation capability values and communication capability values related to the hardware platform.

6. The computation and communication device of claim 4 further comprises a power management unit, wherein the power management unit to collect the computation capability values and communication capability values from the hardware platform before providing the computation capability values and communication capability values to the optimization block.

7. The computation and communication device of claim 6, wherein the power management unit to collect the computation capability values and communication capability values at regular intervals of time.

8. The computation and communication device of claim 6, wherein the power management unit to collect the computation capability values and communication capability values in response to receiving a request from the optimization block.

9. The computation and communication device of claim 4 further comprises an operating system block, wherein the operating system block to determine the one or more energy cost information values.

10. The computation and communication device of claim 8, wherein the operating system block to determine the one or more energy cost information values based on the computation capability values and communication capability values collected from the hardware platform.

11. The computation and communication device of claim 4, wherein the hardware platform further comprises one or more processing cores, wherein the computation capability values are based on an ability of the one or more processors to perform instruction in an unit time.

12. The computation and communication device of claim 4, wherein the hardware platform further comprises a communications module, wherein the communication capability values are based on a bandwidth required by the communications module.

13. The computation and communication device of claim 1, wherein the optimization block is to identify one of the plurality of execution modes best suited to perform the task based on comparing energy consumption value of each of the plurality of execution modes with the one or more of the energy cost information values.

14. The computation and communication device of claim 1, wherein the optimization block to,
receive cloud-side work load information,
determine whether the task is to be performed in one of the plurality of execution modes,
send unprocessed data to the communications block if the task is to be performed in a cloud device, and
receive the processed data from the communication module.

15. The computation and communication device of claim 14, wherein the optimization block to determine the cloud device is best suited to perform the task if the energy consumed by the cloud device is less compared to the energy consumed in one of the plurality of execution modes best suited to perform the task.

16. A method in a computation and communication device comprises determining one of a plurality of execution modes best suited to perform a task based on one or more computation and communication energy cost information values associated with each of the plurality of execution modes,
wherein the computation and communication device includes,
an optimization block, which may determine one of the plurality of execution modes best suited to perform the task,
an application layer, wherein the applications layer to include at least one energy aware application block, wherein the at least one energy aware application block to support the plurality of execution modes.

17. The method of claim 16, wherein each of the plurality of execution modes is associated with a computation requirement values and communication demand values, which is different for the plurality of execution modes.

18. The method of claim 16 comprises determining the computation and communication energy cost information values, in the optimization block, based on a scheduled workload and communication capability values of a hardware platform, wherein the computation and communication device includes the hardware platform.

19. The method of claim 18 further comprises collecting the scheduled workload and the communication capability values related to the hardware platform, wherein the scheduled workload and the communication capability values are collected by the optimization block.

20. The method of claim 19 further comprises collecting the scheduled workload and the communication capability values at regular intervals of time.

21. The method of claim 19 comprises collecting the scheduled workload and the communication capability values in response to a request from the optimization block.

22. The method of claim 19 further comprises determining the energy cost information values in an operating system block before providing the energy cost information values to the optimization block.

23. The method of claim 22 comprises determining the one or more energy cost information values, in the operating system, based on the workload schedule and the communication capability values collected from the hardware platform.

24. The method of claim 22 comprises collecting the workload schedule of one or more processing cores included in the hardware platform.

25. The method of claim 24, wherein the workload schedule of the one or more processing cores to represent the ability of the one or more processing cores to perform additional work along with an already scheduled work.

26. The method of claim 19, wherein the communication capability values are based on a bandwidth required by one or more modems included in a communications module of the hardware block.

27. The method of claim 16 comprises identifying one of the plurality of execution modes best suited to perform the task based on comparing power estimate value of each of the plurality of execution modes with the one or more of the energy cost information values.

28. The method of claim 16 comprises,
receiving a cloud-side work load information,
determining whether the task is to be performed in one of the plurality of execution modes,
sending unprocessed data to the communications block if the task is to be performed in a cloud device, and
receiving the processed data from the communication module.

29. The method of claim 28 comprises determining the cloud device that is best suited to perform the task if the energy consumed by the cloud device is less compared to the energy consumed in one of the plurality of execution modes best suited to perform the task.
